(19) United States
(12) Patent Application Publication
(10) Pub. No.: US 2006/0121288 A1
(43) Pub. Date: Jun. 8, 2006

(54) Fluoropolymer-coated conductor, a coaxial cable using it, and methods of producing them

(76) Inventors: Toshihide Mochizuki, Shizuoka-Shi (JP); Tai Ishima, Shizuoka-Shi (JP); Kazuo Konabe, Shizuoka-Shi (JP)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/283,143

(22) Filed: Nov. 18, 2005

(30) Foreign Application Priority Data
Dec. 3, 2004 (JP) 2004-351928

(51) Int. Cl. B32B 15/04; B32B 27/00

(52) U.S. Cl. 428/421; 428/422; 428/457

(57) ABSTRACT

A fluoropolymer-coated conductor, in which a central conductor is coated with a mixture of at least two fluoropolymers, each having different melting points, one of which is polymers is PTFE, a coaxial cable using the coated conductor, and a method for producing a fluoropolymer-coated conductor in which a central conductor is coated with a mixture obtained by mixing at least two kinds of fluoropolymers, each having different melting points, one of which polymers is PTFE, and heating these at a temperature above the melting point of the lowest melting fluoropolymer and below the melting point of the highest melting fluoropolymer.

### FIELD OF THE INVENTION

This invention concerns a fluoropolymer-coated conductor with little dielectric loss in the high-frequency range, a coaxial cable using it, and methods of producing them.

### DESCRIPTION OF RELATED ART

Insulation on conductors (wires) is a source of dielectric loss in those conductors. Dielectric loss is generated in circuits for high-frequency transmission, coaxial cables of communications systems called “base stations,” LAN cables, flat cables, and other cable applications, small electronic devices, such as mobile telephones, and parts of high-frequency transmission devices, such as printed circuit boards. There is a need for ways of reducing dielectric loss as much as possible. Since dielectric loss is a function of dielectric constant (ε) and dissipation factor (tan δ), it is preferred to make both ε and tan δ small. In addition to having these dielectric properties, wire insulation has requirements for fabricability, heat resistance in order to withstand plating and soldering, and strength, in cases in which cables, etc., are made. Therefore, fluoropolymers, polytetrafluoroethylene (PTFE) in particular, have been used up to now. PTFE has high crystallinity in its as-polymerized state, that is before it is exposed to high temperatures, specifically temperatures above its melting point (about 343° C.). Therefore, it is known that PTFE, in its unsintered state (before heating above its melting point) and semi-sintered state (heated for short times to temperatures below or at least not significantly above its melting point), has good dielectric properties.

In Unexamined Patent Application Publication 2-273416, a coaxial cable is proposed which has an unsintered PTFE insulation layer in which the PTFE insulation layer has been heat-treated below the melting point of the PTFE resin and above the boiling point of the lubricant. In Unexamined Patent Application Publication 2001-357730, a coaxial cable is proposed which has a two-layer insulation layer of low-melting-point PTFE and high-melting-point PTFE, with only the low-melting-point PTFE being sintered, that is, heated above its melting point. In Unexamined Patent Application Publication 2004-172040, an insulated conductor is proposed which has a two-layer insulation in which the inner layer is sintered and the outer layer is unsintered or semi-sintered, as well as coaxial cable which uses this two-layer insulated wire. In Unexamined Patent Application Publication 11-213776, a coaxial cable is proposed which has sintered porous PTFE as the insulation layer, and has an empty space in the insulation layer. Moreover, in Unexamined Patent Application Publication 2004-319216, a coaxial cable is proposed which contains PTFE at a low degree of sintering in its insulation layer.

However, since the demands placed on dielectric properties are becoming more and more stringent, the demands for dielectric properties cannot be satisfied by the insulated electrical wires or coaxial cables that use semi-sintered or unsintered PTFE as insulation such as are disclosed in these applications. Moreover, since semi-sintered or unsintered PTFE does not fuse sufficiently with other PTFE, there is the problem of inferior mechanical strength. Furthermore, there is the problem of the molding process to produce a multi-layer structure with the cured PTFE being complex.

The foregoing mentioned Unexamined Patent Application Publications are incorporated herein by reference: JP 2-273416, JP 2001-357730, JP 2004-172040, JP 11-213776, and JP 2004-319216.

### BRIEF SUMMARY OF THE INVENTION

In a first embodiment this invention provides an insulated conductor comprised of a central conductor coated with a mixture of at least two fluoropolymers having different melting points, wherein said mixture consists of about 70-99.5 wt % of polytetrafluoroethylene and about 30-0.5 wt % of lower melting fluoropolymer, to total 100 wt %.

In a second embodiment this invention provides a method for producing an insulated conductor in which a central conductor is coated with a mixture obtained by mixing at least two kinds of fluoropolymers each having different melting points, said coated central conductor then being heated at a temperature above the melting point of the lowest melting fluoropolymer and below the melting point of the highest melting fluoropolymer, wherein said mixture consists of about 70-99.5 wt % of polytetrafluoroethylene and about 30-0.5 wt % of lower melting fluoropolymer, to total 100 wt %.

In a third embodiment this invention further provides a coaxial cable obtained by using the fluoropolymer-coated conductor mentioned above.

In a fourth embodiment this invention provides a method for producing coaxial cable in which an outer conductor layer is placed on the outer circumference of a fluoropolymer-coated conductor obtained by the aforementioned method.

### DETAILED DESCRIPTION OF THE INVENTION

The fluoropolymer-coated conductor of this invention and the coaxial cable made with it can be used in a wide range of applications, including circuits for high-frequency transmission, coaxial cables of communications systems called “base stations,” LAN cables, flat cables, and other cable applications, small electronic devices, such as mobile telephones, and parts of high-frequency transmission devices, such as printed circuit boards.

By means of this invention, a fluoropolymer-coated conductor is provided that has a low dielectric constant (ε) and a low dissipation factor (tan δ), and the dielectric loss in the high frequency range of which is reduced by maintaining a high degree of crystallization in the fluoropolymer, a coaxial cable using it, and methods of producing them.

This invention provides a fluoropolymer-coated conductor in which a central conductor is coated with a mixture of at least two fluoropolymers each having a different melting point and a coaxial cable obtained from it.

This invention also provides an ideal method for producing this fluoropolymer-coated conductor and the coaxial cable obtained from it.

Preferred mixtures of at least two fluoropolymers with different melting points of this invention are mixtures of polytetrafluoroethylene with at least one fluoropolymer selected from the group consisting of poly(chlorotrifluoroethylene), poly(vinylidene fluoride), and copolymers of these compounds and other fluorine-containing monomers. Specific examples of these are tetrafluoroethylene/hexafluoropropylene copolymer (FEP), tetrafluoroethylene/perfluoro(alkyl vinyl ether) copolymer (PFA), tetrafluoroethylene/ethylene copolymer (ETFE), polychlorotrifluoroethylene (PCTFE), ethylene/chlorotrifluoroethylene copolymer, polyvinylidene fluoride, vinylidene fluoride/hexafluoropropylene copolymer, and tetrafluoroethylene/vinylidene fluoride/hexafluoropropylene copolymer.

The term “polytetrafluoroethylene” (PTFE) means polymer (homopolymer) of tetrafluoroethylene (PTFE) and copolymer of tetrafluoroethylene with about 2 wt % or less of a copolymerizable fluorine-containing monomer (sometimes referred to below as “modified PTFE”). Preferably comonomer content is less than about 1.5 wt %, and more preferably less than about 1 wt %. Like homopolymer PTFE, this modified PTFE is not melt-processible, that is, it cannot be processed with conventional polymer melt processing equipment such as extruders and injection molding machines. Modified PTFE is processed by methods used for homopolymer PTFE, such as by paste extrusion and subsequent sintering.

Preferable examples of the mixture of at least two fluoropolymers with different melting points of this invention are mixtures of PTFE and PFA and/or FEP.

Mixtures of PTFE and PFA and/or FEP in which the heat of fusion of the mixture is 45 J/g or greater are preferred embodiments. If the heat of fusion is in this range, the degree of crystallization can be high and the dissipation factor can be reduced; therefore, a preferred result can be produced in the dielectric properties of the fluoropolymer-coated conductor obtained.

Furthermore, if the mixture, preferably having a heat of fusion of 45 J/g or greater, of the PTFE and the PFA and/or FEP has a specific gravity of 2.2 or greater, a fluoropolymer-coated conductor with excellent mechanical strength, in addition to the excellent dielectric properties due to the reduction of the dissipation factor, can be obtained. This is presumed to be due to the fact that the voids in the fluoropolymer-coated part which are produced by removing the paste extrusion lubricant at a temperature higher than the melting point of the lowest melting fluoropolymer are easily filled in by the melting of the lowest melting fluoropolymer. Therefore, it is especially preferred to use a mixture with a specific gravity of 2.2 or greater if a primary goal is a fluoropolymer-coated conductor with excellent mechanical strength.

Moreover, if the mixture, preferably having a heat of fusion of 45 J/g or greater, of PTFE and PFA and/or FEP has a specific gravity of 1.8 or less, the dielectric constant can be lowered and excellent dielectric properties can be obtained, in addition to the excellent dielectric properties due to the reduction of the dissipation factor. This is presumed to be due to the fact that the voids in the fluoropolymer-coated part which are produced by removing the paste extrusion lubricant by a temperature higher than the melting point of the lowest melting fluoropolymer partially remain. Therefore, it is especially preferred to use a mixture with a specific gravity of 1.8 or lower if a primary goal is a reduction of the dielectric constant of the insulation.

The specific gravity of the mixture can be controlled by the temperature conditions of heating of the mixture coated onto the conductor as shown in Examples 1 to 4.

The invention also provides a method for producing an insulated conductor in which a central conductor is coated with a mixture obtained by mixing at least two kinds of fluoropolymers each having different melting points, and molding is performed at a temperature above the melting point of the lowest melting fluoropolymer and below the melting point of the highest melting fluoropolymer, wherein said mixture consists of about 70-99.5 wt % of polytetrafluoroethylene and about 30-0.5.wt % of lower melting fluoropolymer, to total 100 wt %.

Mixtures of polytetrafluoroethylene with tetrafluoroethylene/perfluoro(alkyl vinyl ether) copolymers and/or tetrafluoroethylene/hexafluoropropylene copolymers can be obtained, by mixing aqueous dispersions of the fluoropolymers. For the typical aqueous fluoropolymer dispersions, the mean particle diameter for the fluoropolymer particles is about 0.10-0.40 μm, and preferably about 0.2-0.3 μm, and a fluoropolymer content of about 25-70 wt % in water is preferred. For example, by mixing a PTFE aqueous dispersion (e.g., one with a mean particle diameter of approximately 0.24 μm) and a PFA aqueous dispersion (e.g., one with a mean particle diameter of approximately 0.24 μm) and/or an FEP aqueous dispersion (e.g., one with a mean particle diameter of approximately 0.24 μm) and then coagulating the polymer by stirring, by freezing and thawing, or with added electrolyte, such as nitric acid, separating the coagulated polymer from the liquid medium, washing and drying the coagulated polymer. Mixtures of PTFE with other lower melting fluoropolymer can be made by a similar process.

The ratio of the PTFE aqueous dispersion to the PFA aqueous dispersion and/or FEP aqueous dispersion is in the range of about 70:30 to 99.5:0.5 (to total 100% on a polymer solids basis), and preferably about 95:5, by weight, which ratios give good surface smoothness and mechanical strength of the fluoropolymer-coated conductor obtained. Furthermore, it is preferred for the mean particle diameter of the mixture after coagulation, washing and drying, to be about 300-600 μm, preferably about 400 μm. These proportions and particles diameters also apply to mixtures of PTFE aqueous dispersion with aqueous dispersion of other lower melting fluoropolymers.

In order to coat the central conductor with the fluoropolymer mixture, one can use ordinary methods for fabricating non-melt processible fluoropolymer, such as paste extrusion.

For example, when the high-melting-point fluoropolymer is PTFE, the mixture obtained by mixing PTFE and at least one fluoropolymer with a lower melting point can be mixed with a known paste extrusion lubricant and compressed to obtain a preform, after which this preform is loaded into a paste extruder and coated onto the central conductor, after which the coating is dried to obtain a conductor coated with the fluoropolymer mixture.

The thickness of the fluoropolymer coating of the fluoropolymer-coated conductor of this invention and the cable using it depends upon the standards and applications of the wire and cable, but is preferably about 0.5-6 mm.

In this invention, a preferred embodiment is to obtain the fluoropolymer-coated conductor by coating a central conductor with a mixture obtained by mixing at least two kinds of fluoropolymers with different melting points, ordinary methods for fabricating non-melt processible fluoropolymer, such as by paste extrusion, followed by heating at a temperature above the melting point of the lowest melting fluoropolymer and below the melting point of the highest melting fluoropolymer. The dielectric constant (ε) and dissipation factor (tan δ) of the fluoropolymer-coated conductor obtained by heating at a temperature above the melting point of the lowest melting fluoropolymer and below the melting point of the highest melting fluoropolymer are lowered, which is beneficial for coated conductors.

If the heating is performed at a temperature below the melting point of the lowest melting fluoropolymer, there is a tendency for the strength and elongation of the article obtained to be inferior. If the heating is performed at a temperature above the melting point of the highest melting fluoropolymer, there is a tendency for degree of crystallization of the fluoropolymer coating to be reduced, and it will be hard to improve the dissipation factor. PTFE is the highest melting fluoropolymer in the mixture, so the heating is sufficient to melt the lower melting fluoropolymer but not high enough to sinter the PTFE.

Furthermore, if only PTFE were used as the fluoropolymer in this invention, it would not be desirable, since the specific gravity of the fluoropolymer coating obtained would be low and the mechanical strength would be inferior; this is believed to be because it would be difficult to fill the voids in the fluoropolymer coating produced by the removal of the paste extrusion lubricant.

The coaxial cable formed by using the fluoropolymer-coated conductor of this invention is a coaxial cable with reduced dielectric loss in the high-frequency range. As methods for forming the coaxial cable from the fluoropolymer-coated electrical wire, one can employ well-known conventional coaxial cable forming methods.

An example of a method of forming a coaxial cable from the fluoropolymer-coated conductor of this invention is a method of forming a coaxial cable by placing an external conductor layer outside the fluoropolymer-coated conductor obtained as described above. Examples of methods of placing the external conductor layer are the method of forming it by metal plating, the method of forming it by winding a metal tape over the fluoropolymer-coated conductor, or the method of braiding a conducting wire.

Since the dielectric loss in the high-frequency range of the fluoropolymer-coated conductor of this invention and the cable using it can be reduced by maintaining a high degree of crystallization of the fluoropolymers, they can be used in various applications, such as circuits for high-frequency transmission, coaxial cables of communications systems called “base stations,” LAN cables, flat cables, and other cable applications, small electronic devices, such as mobile telephones, and parts of high-frequency transmission devices, such as printed circuit boards.

### EXAMPLES

This invention will be explained in more detail below by giving working and comparison examples, but it is not limited by these explanations.

The measurements of the properties in this invention were performed by the following methods.

(1) Maximum Load

Ten millimeter long samples were cut from the coated conductor made in the examples and comparison examples, with the core wires removed, or 10 mm lengths were cut from beads obtained in the Examples, and placed between two parallel plates; a compression load was applied to the samples in the diameter direction. The maximum point stress until it was compressed by 1 mm was measured using a Tensilon tensile tester (Orientech Co., Tokyo, RTC-1310A), and this was taken to be the maximum load.

(2) Dielectric Constant

The dielectric constants ε of the coated conductors obtained in the working examples and comparison examples were obtained using the following formula:
C=24.128ε/log (D1/D2)

ε: dielectric constant
C: capacitance (pF/m) (measured by means of a capacitance monitor (CAPAC® 300-19C with MR.20.200.C detector, Aumbach Electronic AG, Orpund, Switzerland.)
D1: conductor diameter of conductor (mm) D2: finished outer diameter of conductor (mm), measured by means of a laser scanning micrometer (Takikawa Engineering Co., Tokyo, Model No. LDM-303H)
   (3) Specific Gravity

The specific gravities of the fluoropolymer coatings on the conductors were obtained by the JIS K7112-A method (water displacement method) or ASTM D 792. Measurements were made on the coatings with the conductors removed.

(4) Measuring Heat of Fusion

A differential scanning calorimeter (Model Pyris 1 DSC, Perkin Elmer Co.). A 10 mg sample was weighed and put into an aluminum pan; after the pan was crimped closed, the sample was put into the DSC and the temperature was raised from 150° C. to 360° C. at 10° C./min. The heat of fusion was obtained from the (melting endotherm) peak area, defined by connecting the point at which the curve deviates from the baseline and the point at which it returns to the baseline before and after the melting peak with a straight line.

Dissipation Factor

The sample powder was compression-molded to circular plates 50 mm in diameter and 2 mm thick with a pressure of 150 kg/cm² and both surfaces of the plates were completely polished to a mirror finish with No. 600 sandpaper. After this, the plates were heated for 30 minutes at the temperatures shown in Table 2. After heating, the plates were cooled to room temperature at a cooling rate of 60° C./hr to obtain test pieces. The dissipation factors of these test pieces at 12 GHz were measured by the cavity resonator method (described in Denshi Joho Gakkaishi MW87-7 (1987)).

Production of Sample Powder

An aqueous dispersion of PTFE (FEP-modified, 0.3 wt %) obtained by emulsion polymerization (mean particle diameter 0.24 μm, melting peak temperature 343° C. (first melt)) and an aqueous dispersion of PFA (mean particle diameter 0.24 μm, melting peak temperature 290° C.) were mixed in the ratio of 95:5 as the solid weights of the polymers; the mixture was prepared so that the total solids concentration was 15-20 wt %. After the mixture was stirred and polymer was coagulated, it was dried for 10 hours at 150° C. and a sample powder with a mean particle diameter of about 300-600 μm was obtained.

### Examples 1 and 2

One hundred parts by weight of the above prepared sample powder (95:5 by weight modified PTFE:PFA) and 19.8 parts by weight hydrocarbon lubricant (Isopar E, Exxon Chemical Co.) were mixed and left standing for 12 hours to obtain paste extrusion mixtures. The paste extrusion mixtures so obtained were put into cylindrical molds (inner cylinder diameter 70 mm, outer mandrel diameter 15.9 mm) and preforms were made at a pressure of 10 kg/cm² at room temperature, that is about 20-25° C. The preforms were put into cylinders with extrusion guides attached (the cylinders and extrusion guides were heated to 50° C.) and the outsides of copper conductors with an outer diameter of 0.911 mm were coated by paste extrusion at a line speed of 3.75 m/min. The thickness of the coating was 0.945 mm. After this, the lubricant was removed by passing the sample continuously through a heating furnace divided into five temperature zones, shown in Table 1 (48 seconds for each pass); wires with the outer diameters shown in Table 1 were obtained. Because of the short contact time in each zone (48 seconds), the fluoropolymer does not reach the set temperature of the zone and the temperature of the fluoropolymer insulation is less than the 343° C. melting point of the PTFE. Analysis of the fluoropolymer insulation properties (see the next paragraph) shows the effect of the temperatures.

After cooling, the dielectric constants and maximum loads (measured on the insulation with conductor removed) of the coated conductors so obtained were measured. The copper conductors were extracted, and the specific gravities and the heat of fusion of the fluoropolymers coating the electrical wires were measured. The results are summarized in Table 1. Example 1 shows that when Zones 4 and 5 are set at 360° C., the fluoropolymer mixture is heated enough so that voids left by the loss of lubricant are filled by the lower-melting-point fluoropolymer of the mixture. That is to say, the lower-melting-point fluoropolymer of the mixture is sufficiently melted so that it flows into the voids, filling them. This is shown by the specific gravity in the “Specific gravity of the molded article” row of Table 1, 2.232. However, the fluoropolymer mixture was not heated above the melting point of the PTFE component of the mixture as can be seen by the high heat of fusion, 54.3 J/g. As can be seen in Comparison Example B (see below), in which Zones 4 and 5 are at 420° C., well above the about 343° C. melting point of as-polymerized PTFE, such high temperature exposure reduces the heat of fusion substantially, to 20.2 J/g in this case.

In contrast, in Example 2, in which Zones 4 and 5 are set at 350° C., the specific gravity is lower, 1.780, indicating that the lower-melting-point fluoropolymer of the mixture did not melt sufficiently to fill completely the voids left by the loss of lubricant. The heat of fusion is 66.5 J/g, indicating good retention of crystallinity in the fluoropolymer coating. The maximum load of Example 2, 103 N, is lower than that of Example 1, 473 N. This is attributable to the voids remaining in the Example 2 insulation.

### Comparison Examples A and B

Fluoropolymer-coated conductors having the outer diameters shown in Table 1 were obtained in the same manner as in Example 1, except that the sample powder used was PTFE powder (mean particle diameter 400 μm, peak melting temperature, as solid, 343° C.) alone, without other fluoropolymer of lower melting point. The dielectric constants and maximum loads of the coated conductors were measured. The conductors were extracted and the specific gravities and the head of fusion of the PTFE coating the electrical wires were measured. The results are summarized in Table 1.

TABLE 1

| | | Example | Example | Comparison | Comparison |
|---|---|---|---|---|---|
| | | 1 | 2 | Example A | Example B |
| PTFE:PFA (wt/wt) | | 95:5 | 95:5 | 100:0 | 100:0 |
| Set temperature of | Zone 1 | 100 | 100 | 100 | 100 |
| furnace (° C.) | Zone 2 | 120 | 120 | 120 | 120 |
| | Zone 3 | 140 | 140 | 140 | 140 |
| | Zone 4 | 360 | 350 | 360 | 420 |
| | Zone 5 | 360 | 350 | 360 | 420 |

| | | | | |
|---|---|---|---|---|
| Diameter coated conductor (mm) | 2.39 | 2.56 | 2.50 | 2.38 |
| Specific gravity of molded article | 2.232 | 1.780 | 1.928 | 2.150 |
| Heat of fusion (J/g) | 54.3 | 66.5 | 47.2 | 20.2 |
| Maximum load (N) | 473 | 103 | 170 | 500 |
| Dielectric constant ε | 2.05 | 1.79 | 1.87 | 2.05 |

### Examples 3 and 4, and Comparison Example C

One hundred parts by weight of the above prepared sample powder (95:5 by weight modified PTFE:PFA) and 19.0 parts by weight hydrocarbon lubricating agent (Isopar E, Exxon Chemical Co.) were mixed and left standing for 12 hours to obtain a paste extrusion mixture. The paste extrusion mixtures obtained were put into cylindrical molds (inner cylinder diameter 31.7 mm) and preforms were made at a pressure of 10 kg/cm² at 20-25° C. The preforms were put into cylinders (reduction ratio (RR) 100) with extrusion guides attached and paste extrusion was performed at about 50° C. In Examples 3, 4, and Comparison Example C, bead was extruded, that is a solid strand of fluoropolymer, in contrast to the extrusion on conductor done in the preceding examples. Because of this difference in the extrudate, all the measured properties are not comparable between the two sets of examples. However, the heats of fusion and specific gravity can be compared. The reduction ratio (RR) is the ratio of the cross sectional area of the cylinder (S2) filled with the paste mixture to the cross sectional area at the die outlet (S1), i.e., S2/S1. The beads obtained were heated for 30 minutes in a heating furnace set at the temperatures shown in Table 2 and cooled to room temperature at a cooling rate of 60° C./hr and the maximum loads, specific gravities, and heats of fusion were measured. The results are summarized in Table 2. In addition, the dissipation factors of the sample powders were measured.

The results of Examples 3 and 5 show that the dissipation factor (tan δ) is lowered by heating at a temperature above the melting point of the lowest melting fluoropolymer and below the melting point of the highest melting fluoropolymer. Furthermore, by controlling the heating temperature, the specific gravity of the resulting fluoropolymer can be controlled to give higher specific gravity, 2.257 when the temperature is higher, and lower, 1.738, when the temperature is lower. Maximum load parallels specific gravity, as in Examples 1 and 2, and the high heats of fusion show that high crystallinity is preserved for these fluoropolymer mixtures heated below the melting point of the higher melting polymer (PTFE).

Comparison Example C shows the effect of heating the fluoropolymer mixture above the melting point of the higher melting polymer (PTFE). Heat of fusion is reduced, indicating loss of crystallinity.

TABLE 2

| | Example | Example | Comparison |
|---|---|---|---|
| | 3 | 4 | Example C |
| PTFE:PFA (wt/wt) | 95:5 | 95:5 | 95:5 |
| Furnace temperature | 338 | 326 | 380 |
| setting (° C.) | | | |
| Specific gravity of | 2.257 | 1.738 | 2.160 |
| molded article | | | |
| Heat of fusion (J/g) | 55.6 | 69.4 | 31.8 |
| Maximum load (N) | 607.1 | 137.4 | 588.6 |
| Dissipation factor δ | 0.00035 | 0.00030 | 0.00041 |

The fluoropolymer-coated conductor and the coaxial cable using it that are provided by this invention are a fluoropolymer-coated conductor and coaxial cable made with said coated conductor with lowered dielectric loss in the high-frequency range, with a low dielectric constant (ε) and a low dissipation factor (tan δ). Therefore, they are ideal for use in a wide range of applications, such as circuits for high-frequency transmission, coaxial cables of communications systems called “base stations”, LAN cables, flat cables, and other cable applications, small electronic devices, such as mobile telephones, and parts of high-frequency transmission devices, such as printed circuit boards.

This invention also provides production methods for easily producing a fluoropolymer-coated conductor and a coaxial cable using it with lowered dielectric loss in the high-frequency range, with a low dielectric constant (ε) and a low dissipation factor (tan δ).

What is claimed is:

1. An insulated conductor comprised of a central conductor coated with a mixture of at least two fluoropolymers having different melting points, wherein said mixture consists of about 70-99.5 wt % of polytetrafluoroethylene and about 30-0.5 wt % of lower melting fluoropolymer, to total 100 wt %.

2. The insulated conductor of claim 1, wherein said mixture of fluoropolymers is a mixture of polytetrafluoroethylene with at least one other fluoropolymer having a lower melting point, selected from the group consisting of tetrafluoroethylene/hexafluoropropylene copolymer, tetrafluoroethylene/perfluoro(alkyl vinyl ether) copolymer, tetrafluoroethylene/ethylene copolymer, polychlorotrifluoroethylene, ethylene/chlorotrifluoroethylene copolymer, polyvinylidene fluoride, vinylidene fluoride/hexafluoropropylene copolymer, and tetrafluoroethylene/vinylidene fluoride/hexafluoropropylene copolymer.

3. The insulated conductor of claim 1, wherein said mixture of fluoropolymers is a mixture of polytetrafluoroethylene with tetrafluoroethylene/perfluoro(alkyl vinyl ether) copolymer and/or tetrafluoroethylene/hexafluoropropylene copolymer.

4. The insulated conductor of claim 3, wherein the heat of fusion (ΔH) of said mixture of polytetrafluoroethylene and tetrafluoroethylene/perfluoro(alkyl vinyl ether) copolymer and/or tetrafluoroethylene/hexafluoropropylene copolymer is 45 J/g or greater, and its specific gravity is 2.2 or greater.

5. The insulated conductor of claim 3, wherein the heat of fusion (ΔH) of said mixture of polytetrafluoroethylene and tetrafluoroethylene/perfluoro(alkyl vinyl ether) copolymer and/or tetrafluoroethylene/hexafluoropropylene copolymer is 45 J/g or greater, and its specific gravity is 1.8 or less.

6. The insulated conductor of claim 1, obtained by coating a central conductor with a mixture of fluoropolymers and heating the coated conductor at a temperature above the melting point of the lowest melting fluoropolymer and below the melting point of the highest melting fluoropolymer.

7. A coaxial cable comprising the insulated conductor of claims 1.

8. A method for producing an insulated conductor in which a central conductor is coated with a mixture obtained by mixing at least two kinds of fluoropolymers each having different melting points, said coated central conductor then being heated at a temperature above the melting point of the lowest melting fluoropolymer and below the melting point of the highest melting fluoropolymer, wherein said mixture consists of about 70-99.5 wt % of polytetrafluoroethylene and about 30-0.5 wt % of lower melting fluoropolymer, to total 100 wt %.

9. The method of claim 8, wherein said mixture of fluoropolymers is comprised of polymers having different melting points, one said fluoropolymer being polytetrafluoroethylene, and at least one other lower melting fluoropolymer being selected from the group consisting of tetrafluoroethylene/hexafluoropropylene copolymer, tetrafluoroethylene/perfluoro(alkyl vinyl ether) copolymer, tetrafluoroethylene/ethylene copolymer, polychlorotrifluoroethylene, ethylene/chlorotrifluoroethylene copolymer, polyvinylidene fluoride, vinylidene fluoride/hexafluoropropylene copolymer, and tetrafluoroethylene/vinylidene fluoride/hexafluoropropylene copolymer.

10. The method of claim 9, wherein the highest melting fluoropolymer is polytetrafluoroethylene and the lower-melting-point fluoropolymer is tetrafluoroethylene/perfluoro(alkyl vinyl ether) copolymer and/or tetrafluoroethylene/hexafluoropropylene copolymer.

11. A method for producing coaxial cable, wherein an outer conductor layer is placed on the outer circumference of the insulated conductor of claim 8.
